(19) United States
(12) Patent Application Publication
(10) Pub. No.: US 2012/0039773 A1
(43) Pub. Date: Feb. 16, 2012

(54) CONNECTION SYSTEM FOR SENSOR CARTRIDGE

(75) Inventors: Maurice Hubertus Elisabeth Van Der Beek, Eindhoven (NL); Petrus Leonardus Adrianus Van Der Made, Boxtel (NL); Jan Hendrik Verhagen, Sleeuwijk (NL)

(73) Assignee: KONINKLIJKE PHILIPS ELECTRONICS N.V., EINDHOVEN (NL)

(21) Appl. No.: 13/203,119

(22) PCT Filed: Feb. 22, 2010
(86) PCT No.: PCT/IB2010/050761

§ 371 Date: Oct. 27, 2011

(30) Foreign Application Priority Data
Feb. 27, 2009 (EP) 09153950.2

(51) Int. Cl. B01L 99/00; B23P 11/00

(52) U.S. Cl. 422/544; 29/428

(57) ABSTRACT

The invention relates to a sensor cartridge for the examination of a liquid or solid sample, particularly a biological fluid like saliva or blood To this end provided is a connection system (1, 2, 3) for the connection of a cartridge (3) to a cartridge reader (1), comprising a sample collection device (2) for picking up a sample releasably connected to the cartridge (3) via a first locking device (5) before taking the sample whereby the cartridge (3) is releasably connected to the reader (1) via a second locking device (6).

The invention relates to a connection system for a sensor cartridge for the examination of a liquid or solid sample, particularly a biological fluid like saliva or blood.

The US 2004/0082878 A1 discloses an oral fluid collection and transfer device comprising a collection device and a test cartridge. The test cartridge has a collection chamber to allow insertion of the collection device into the test cartridge. The collection device is located at a fixed location within the collection chamber, in which location an absorbing pad undergoes a controlled degree of compression, thereby transferring a predetermined volume of oral fluid from the absorbing pad to a test strip.

Based on this situation it was an object of the present invention to provide alternative means for connecting sample collection devices with a cartridge and a detection device or reader, wherein it is desirable that these means can be produced at low costs, are easy-to-use, and allow for precise and flexible measurements.

This object is achieved by a connection system according to claim 1 and a connection method according to claim 10. Preferred embodiments are disclosed in the dependent claims.

The connection system according to the present invention serves for the

connection of a cartridge to a cartridge reader with the features of a sample collection

device for picking up a sample releasably connected to the cartridge via a first locking

device before taking the sample, whereby the cartridge is releasably connected to the reader via a second locking device.

The described connection system has the advantage to provide for a reliable and convenient coupling to an external reader device. It is possible to use elaborate sensing and data processing technologies, because expensive and bulky components can be disposed in the reusable reader or reader device while consumables that come into contact with the sample are separately housed in the cartridge of the sensor, whereby the cartridge and the sample collection device are generally disposable.

The invention enables an easy and unambiguous workflow of taking a sample and analyzing the sample with easy handling, especially advantageous for use in a non-laboratory environment, e.g. for road-side testing. First, the sample collection device and the cartridge are connected with the reader. In a first step the sample collection device is released from the cartridge, the cartridge still being connected to the reader. In a second step a sample is taken by the sample collection device and the sample collection device containing a sample is connected to the cartridge again. In a third step the sample is analyzed in the reader by any of recently known methods. In a further step the sample collection device and the cartridge connected thereto are removed from the reader, giving the possibility to repeat the described steps with different sample collection devices and cartridges.

Due to their coupling to an external reader, the sample examination means, hereto referred to as reader, are not restricted to simple ones (e.g. color changes) that must immediately be observed by a user.

Examples of the present invention are disclosed in the dependent claims.

According to one example the first locking device of the connection system is a flap ring concentrically arranged at the cartridge with flaps at the edge of the flap ring designed to project into recesses within the sample collection device establishing a releasable connection between the cartridge and the sample collection device. Thereby, an effective and cheap connection between the sample collection device and the cartridge is designed, which is releasable by a certain force applied to the sample collection device.

According to an alternative example the first locking device is a bendable cantilever projecting through the cartridge for engagement into a groove formed in the sample collection device at one end of the cantilever. A wedge is provided at the reader for pressing the cantilever at the other end to bend the cantilever in a direction away from the sample collection device to disconnect the cartridge from the sample collection device. Likewise to the alternative first locking device described above a cheap and effective realization is designed.

According to another example of the invention the second locking device is a ball-spring lock arranged at the reader for engagement into a groove designed in the cartridge for releasably locking the cartridge to the reader before taking the sample. The ball-spring has a spring force directed to the cartridge by which the cartridge is locked in a groove formed in the cartridge to hold the cartridge in this position.

According to another example the second locking device exerts a force on the cartridge perpendicular to the cartridge and the sample collection device resulting in a force in the axial direction to the cartridge and the sample collection device higher than exerted by the first locking device allowing to release the sample collection device from the cartridge and the cartridge locked with the reader. By this feature a simple example is given for releasing the sample collection device from the cartridge before the sample is taken from a person, whereby the cartridge stays at the reader.

In another example of the connection system a third locking device is arranged at the cartridge for irreversibly locking the sample collection device with the cartridge to withdraw the sample collection device with the cartridge from the reader. The third locking device assures the connection of the sample collection device to the cartridge after the sample is taken and provided to the reader. By means of the third locking device the disposable sample collection device and the cartridge are reliably releasable from the reader which is then ready for further operation.

As an example of the third locking device a clamp is described arranged at the cartridge for engagement into a groove designed in the sample collection device for irreversibly locking the cartridge to the sample collection device after taking the sample.

The cartridge reader or reader may comprise an optical, magnetic, mechanical, acoustic, thermal or electrical sensor element for sensing the sample. The sensor element may be or comprise any sensitive unit that is suited for sensing the parameter of interest from a sample to be tested. Preferably, the sensor element comprises an optical, magnetic, mechanical, acoustic, thermal and/or electrical microelectronic sensor element. A magnetic sensor element may particularly comprise a coil, Hall sensor, planar Hall sensor, flux gate sensor, SQUID (Superconducting Quantum Interference Device), magnetic resonance sensor, magneto-restrictive sensor, or magneto-resistive sensor of the kind described in the WO 2005/010543 A1 or WO 2005/010542 A2, especially a GMR (Giant Magneto Resistance), a TMR (Tunnel Magneto Resistance), or an AMR (Anisotropic Magneto Resistance). An optical sensor element may particularly be adapted to detect variations in an output light beam that arise from a frustrated total internal reflection due to target particles at a sensing surface. Other optical, mechanical, acoustic, and thermal sensor concepts are described in the WO 93/22678, which is incorporated into the present text by reference.

As another feature the reader of the connection system comprises an indicator for detecting and indicating if sufficient sample is collected. If the indicator gives a signal at the reader the user is aware of a sufficient amount of sample and can remove the sample collection device connected to the cartridge. If not sufficient sample is provided to the reader the user has to wait until the sample is provided to the detection area of the reader or take another sample.

Also a method is claimed for the connection of a cartridge to a cartridge reader, characterized by

connecting a sample collecting device and a cartridge to the reader,

releasing the sample collecting device from the cartridge leaving the cartridge connected to the reader,

taking a sample by the sample collecting device,

irreversibly connecting the sample collecting device with the cartridge connected to the reader,

detecting the sample within the reader,

removing the sample collecting device and the cartridge irreversibly connected to the sample collecting device from the reader.

These and other aspects of the invention will be apparent from and elucidated with reference to the embodiment(s) described hereinafter. These embodiments will be described by way of example with the help of the accompanying drawings in which:

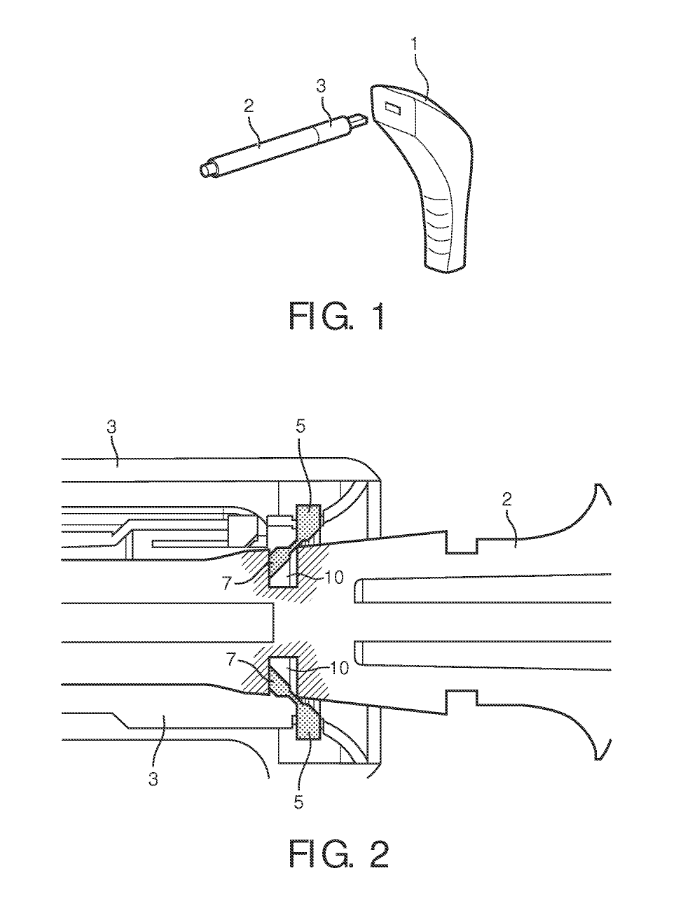

FIG. 1 shows a perspective view of a connection system with a reader and a sample connection device connected to a cartridge before the connection of to sample connection device and the cartridge to the reader in a very schematic way;

FIG. 2 shows a cross section through the cartridge at the left side and the sample collection device at the right side partly inserted into the cartridge with a first locking device of the cartridge connected to the sample connection device within a recess in the sample collection device for releasable connection of the sample collection device to the cartridge before taking a sample;

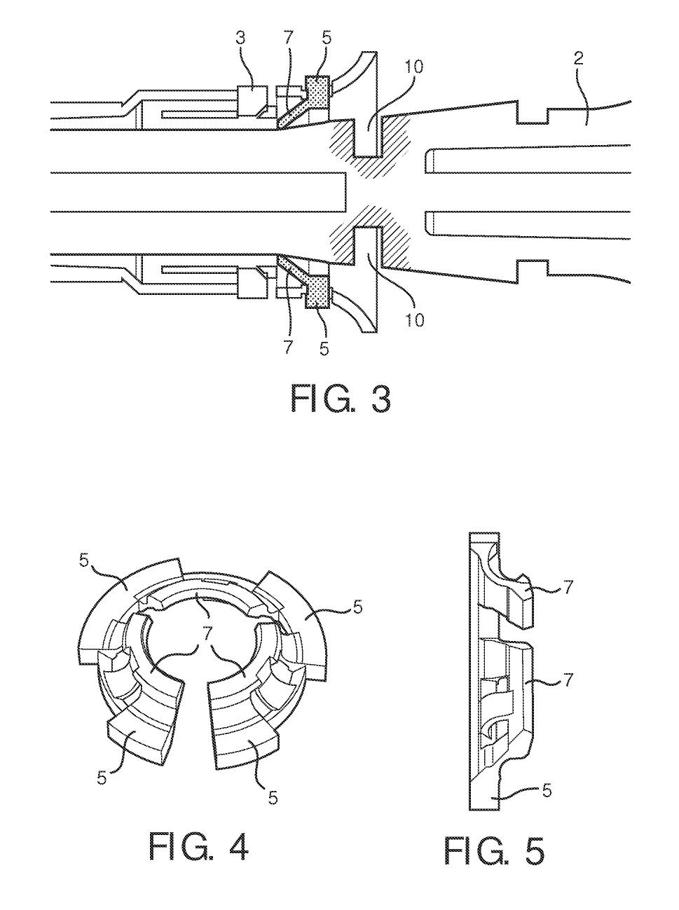

FIG. 3 shows a similar view as FIG. 2 with a cross section through the cartridge at the left side and the sample collection device at the right side with a first locking device of the cartridge before connection to the sample connection device after taking the sample;

FIG. 4 shows a perspective view of an example of the first locking device designed as a flap ring with flaps arranged in the cartridge for engagement to a recess in the sample collection device;

FIG. 5 shows the example of FIG. 4 as a cutted side view;

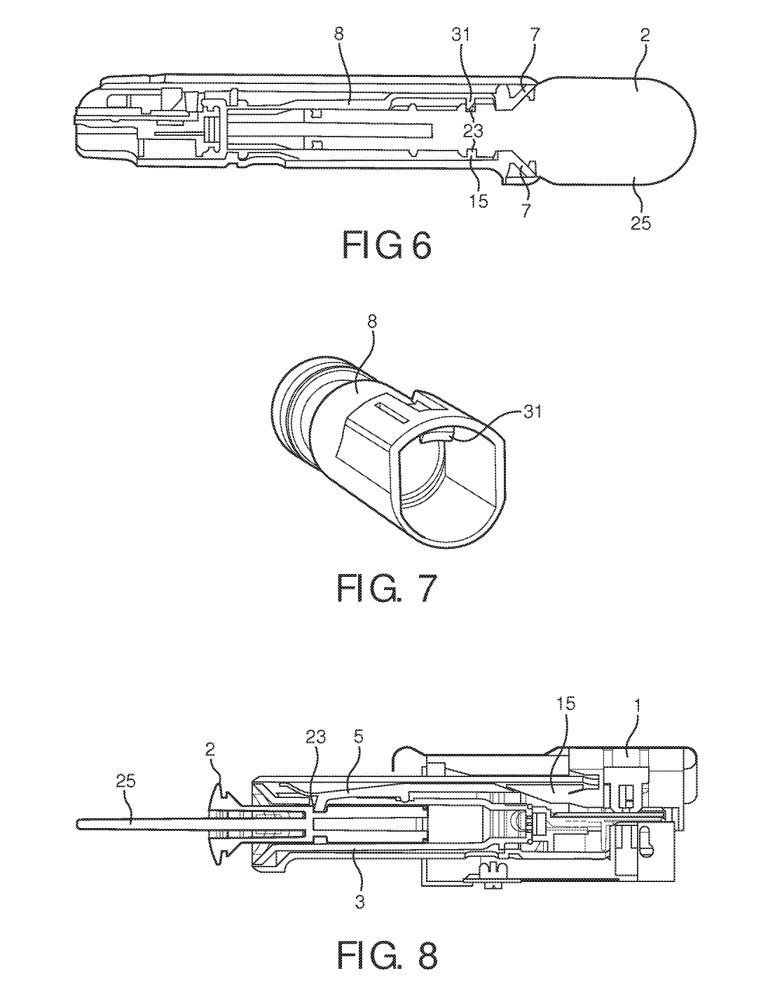

FIG. 6 shows a cross section of the sample collection device connected to the cartridge, both connected to the reader for detecting the sample provided by the sample collection device, with a third locking device for irreversible locking the sample collection device to the cartridge before removing the sample collection device and the cartridge from the reader;

FIG. 7 shows a perspective view of a squeeze tube with integrated spring element and notch as part of the cartridge for illustrating an example of the third locking device according to FIG. 6;

FIG. 8 shows a cross section of an alternative first locking device within the cartridge connected to a groove within the sample collection device for a releasable connection of the sample collection device to the cartridge, with the cartridge connected to the reader shown in a cutted part;

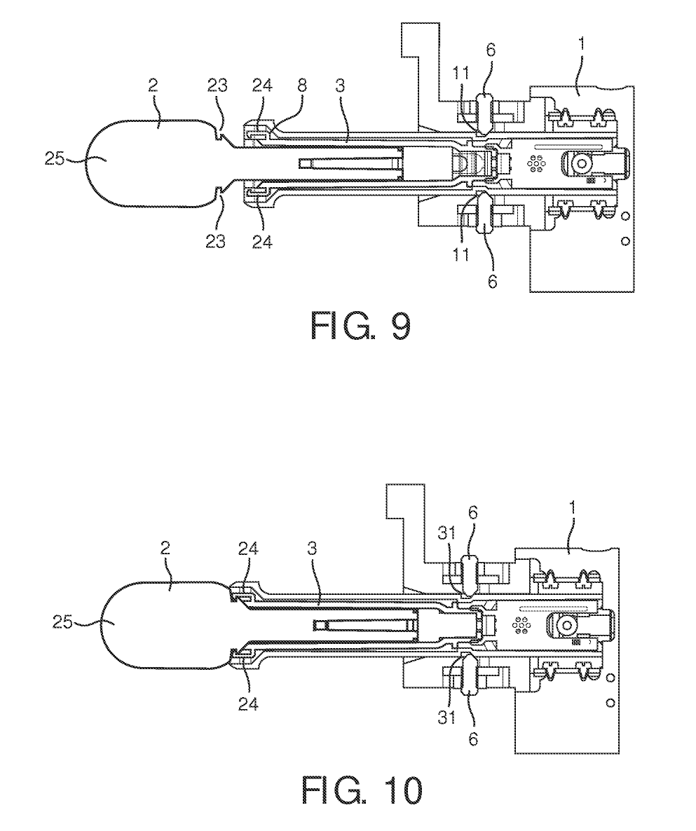

FIG. 9 shows a cross section similar to the alternative of FIG. 8 shifted by 90° with a clamp at the cartridge as an alternative third locking device to engage in a notch in the sample collection device;

FIG. 10 shows a view similar to FIG. 9 with the clamp of the cartridge irreversible engaged into the notch in the sample collection device allowing to withdraw the sample collection device and the cartridge from the reader after detection of the sample by the reader.

FIG. 1 shows a perspective view of a connection system 1, 2, 3 with a reader 1 at the right side of FIG. 1 including a detection device for detecting a sample provided by the sample collection device 2 connected to a cartridge 3 at the left side. The sample is for instance saliva taken from a person in a roadside test, the detection device inside the reader can be an optical detection device, other detection devices are designable. In FIG. 1 the sample collection device 2 and the cartridge 3 are in the original position as also shown in FIG. 2. In this position the sample collection device 2 and the cartridge 3 can be handled as one part taken from a packaging containing these parts.

In detail FIG. 2 shows a cross section through a part of the cartridge 3 at the left side which encompasses the sample collection device 2 in parts. The cartridge 3 comprises a housing at the outside and a module at the inside. The cartridge 3 comprises a first locking device 5, here attached to the module of the cartridge 3, which is in the example shown as a flap ring 5 comprising flaps 7, also shown in FIGS. 4 and 5 more clearly. Housing and module of the cartridge 3 are fixed permanently. Two flaps 7 are shown in FIG. 2 in cross section projecting from the flap ring 5 in the direction towards the sample collection device 2. The first locking device 5 of the cartridge 3 is hereby releasably connected to a recess 10 in the sample collection device 2. Here, the recess 10 is formed around the whole diameter of the sample collection device 2. The flaps 7 positioned into the recess 10 prevent the sample collection device 2 from further insertion into the cartridge 3, as can be seen in FIG. 2. A swab (not shown) is attached to the tip of the sample collection device 2 inserted into the cartridge 3 for absorbing the sample, this swab is deformation protected by the first locking device 5 holding the sample collection device 2 from further insertion. The sample collection device 2 is also prevented from falling out of the cartridge 3. In this position the sample collection device 2 is before a sample from a person is taken and before the detection of the sample in the reader 1 starts. The sample collection device 2 and the cartridge 3 in the position shown can be handled by the user as one part, regularly the user takes the both parts from the packaging when a sample detection is about to start. Only upon applying a certain amount of force the sample collection device 2 can be pulled away from the cartridge 3, thereby unlocking or releasing the first locking device 5. As the flaps 7 around the flap ring 5 own a certain flexibility the flaps 7 are bend to the right direction when pulling at the sample collection device 2 and follow the pull of the sample collection device 2. The flap ring 5 meanwhile stays in its position. Flap ring 5 with flaps 7 are shown in FIG. 4 and FIG. 5 in more detail. The flap ring 5 has in an example two stable positions, so called bi-stable, one position shown in FIG. 2 and FIG. 3, in the other stable position the flaps 7 are directed to the right side as to FIG. 2 and FIG. 3, illustrated in FIG. 6. In this design with two stable positions the flaps 7 are bend under application of force and snap form one to the other stable position. The flap ring 5 with flaps 7 can be milled from polypropylene.

The sample collection device 2 connected releasably to the cartridge 3 according to FIG. 3 is connected to the reader 1 by partly inserting the cartridge 3 into a corresponding opening in the reader 1. By insertion the cartridge 3 is releasably connected to the reader 1 by a second locking device 6, as will be described later. In this position the connection system 1, 2, 3 is connected as one part by the first locking device 5 and by the second locking device 6.

In a further step the sample collection device 2 is disconnected from the cartridge 3 by pulling the sample collection device 2 in a direction away from the cartridge 3 and the reader 1 releasably connected to the cartridge 3. The sample collection device 2 is released from the cartridge 3 as the flaps 7 snap to a different stable position as described above allowing the flaps 7 to be released from the recess 10 and the sample collection device 2 to be released from the cartridge 3 correspondingly. The cartridge 3 keeps to be releasably connected to the reader 1, as the force needed to disconnect the sample collection device 2 from the cartridge 3 is lower than the force needed to disconnect the cartridge 3 from the reader 1. In other words the second locking device 6 exerts a force on the cartridge 3 perpendicular to the cartridge 3 and the sample collection device 2 resulting in a force in the axial direction to the cartridge 3 and the sample collection device 2 higher than the force exerted by the first locking device 5 allowing to release the sample collection device 2 from the cartridge 3. Thus, the cartridge 3 is still locked with the reader 1. The second locking device 6 is described later in detail.

Now, the sample collection device 2 is taken from the cartridge 3 and handled freely to collect the sample from a person subjected to the test to be done, for instance saliva in a road-side drug test. After the sample is taken, e.g. by a swab at the sample collection device 2, the sample collection device 2 is again partly inserted into the cartridge 3 which is still connected to the reader 1 as shown in FIG. 3. In FIG. 3 therefore the sample collection device 2 is moved from the right side to the left side by the user.

In the following the structure and function of the second locking device 6 and a third locking device 8 is described in detail. FIG. 6 shows a cross section of the sample collection device 2 connected to the cartridge 3, with a grip 25 for handling of the sample collection device 2. In FIG. 6 the sample collection device 2 is irreversibly connected to the cartridge 3 by the third locking device 8 incorporated in the cartridge 3. The third locking device 8 in this example is a squeeze tube according to FIG. 7 comprising a notch 31 at one end of a spring element of the squeeze tube. When inserting the sample collection device 2 into the cartridge 3 after taking the sample the notch 31 is biased by the spring element against the sample collection device 2. As can be seen the flaps 7 of the flap ring 5 are still bend in a stable open position. By pushing the sample collection device 2 with a sufficient force and distance into the cartridge 3 the notch 31 of the third locking device 8 falls within a groove 23 formed in the sample collection device 2. The sample collection device 2 and the cartridge 3 are hereby connected in an irreversible way, i.e. the two parts are not supposed to be divided again. The sample taken is now transported to an area within the reader 1 to allow the detection of a substance in the sample, which is known in the art and not subject of this invention. As the sample collection device 2 and the cartridge 3 are now irreversibly connected to each other and the purpose of providing a sample to the reader 1 is achieved the both parts are removed from the reader 1 and disposed. Another measurement will take place with the same reader 1 and other disposable sample collection devices 2 and cartridges 3.

FIGS. 8-10 show alternative examples of the first, second and third locking devices 5, 6, 8 incorporating the same inventional principle. Shown in FIG. 8 is a cross section of the sample collection device 2 according to the example above. An alternative first locking device 5 within the cartridge 3 is designed as a bendable cantilever 5 projecting within the cartridge 3. The cantilever 5 of the cartridge 3 is releasably connected to the sample collection device 2 by engagement into a groove 23 within the sample collection device 2 at one end of the cantilever 5. In the position shown in FIG. 8 the connection system 1, 2, 3 is in the status before the sample is taken and even before the cartridge 3 is connected to the reader 1, shown in cut part at the left side. By pushing the sample collection device 2 in the direction of the cartridge 3 and the reader 1, a wedge 15 designed within the reader 1 presses against one end of the cantilever 5 which is thereby subjected to bending stress as one precondition to unlock the sample collection device 2 from the cartridge 3. A second precondition for unlocking is a retraction force from pulling the sample collection device 2. The cantilever 5 has an under-cut in the part at which it is connected to the sample collection device 2. The under-cut prevents the cantilever 5 from being lifted away from the groove 23 only by the bending moment generated by the force exerted by the wedge 15. Due to the under-cut in the cantilever 5 it is stuck to the sample collection device 2 and cannot disconnect from the sample collection device 2 until the sample collection device 2 is pulled out of the reader 1. Then, the cantilever 5 slides from the under-cut and thus is released because the bending moment still acts on the cantilever 5. In summary, by pushing the cartridge 3 against the wedge 15 and subsequent pulling of the sample collection device 2 away from the cartridge 3 the cantilever 5 at the opposed end of the wedge 15 is lifted out of the groove 23. By lifting the cantilever 5 the engagement of the cantilever 5 within the groove 23 is revoked, i.e. the first locking device 5 is disconnected, causing the sample collection device 2 to be retractable out of the cartridge 3. Concurrently, the second locking device 6 formed at the reader 1 connects to the cartridge 3, as is shown in FIG. 9. FIG. 9 shows a cross section similar to the alternative of FIG. 8 shifted by 90° around the longitudinal axis. The second locking device 6 in this example is designed as two ball-spring locks opposed to each other which engage into recesses 11 at the cartridge 3 to releasably connect the reader 1 to the cartridge 3. The spring forces of the ball-spring locks press the balls into the recesses 11 such that the cartridge 3 is fixated into the reader 1. Similar to the description above for the first example the force that the ball-springs exert are higher than the force needed to retract the sample collection device 2 from the cartridge 3. As described under FIG. 8 the cantilever 5 is in this status removed from the sample collection device 2, so the sample collection device 2 can be withdrawn from the cartridge 3, whereby the cartridge 3 is held in the reader 1 by the second locking device 6, here the ball-spring locks. With the sample collection device 2 now a sample is taken from a person corresponding to the first example of the invention above. FIG. 10 shows a view similar to FIG. 9 whereby the sample collection device 2 is again inserted into the cartridge 3 after the sample is taken. This time the sample collection device 2 is put into the cartridge 3 until a clamp 24 designed around the end of the module of the cartridge 3 engages into a groove 23 formed in the grip of the sample collection device 2. The clamp 24 is formed by example all around the cartridge 3 and has a flexible material to be bend to a small amount when abut against the grip 25 before clamping into the groove 23. The clamp 24 at the cartridge 3 engaging into the groove 23 functions as the third locking device 8 in this example. The connection established by this engagement is irreversibly, which again means that the sample collection device 2 and the cartridge 3 are not disconnected again and disposed together. The irreversible connection of the sample collection device 2 with the cartridge 3 has the effect that by pulling at the grip 25 of the sample collection device 2 in the direction away from the reader 1 the releasable second locking device 6 is disconnected, the balls of the ball-spring locks are drawn away from the recess 11, the sample collection device 2 and the cartridge 3 are removed from the reader 1.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. Connection system (1, 2, 3) for the connection of a cartridge (3) to a cartridge reader (1), comprising
a sample collection device (2) for picking up a sample releasably connected to the cartridge (3) via a first locking device (5) before taking the sample;
whereby the cartridge (3) is releasably connected to the reader (1) via a second locking device (6).

2. The connection system (1, 2, 3) according to claim 1,
characterized in that the first locking device (5) is a flap ring concentrically arranged at the cartridge (3) with flaps (7) at the edge of the flap ring designed to project into recesses (10) within the sample collection device (2) establishing a releasable connection between the cartridge (3) and the sample collection device (2).

3. The connection system (1, 2, 3) according to claim 1,
characterized in that the first locking device (5) is a bendable cantilever projecting through the cartridge (3) for engagement into a groove (11) formed in the sample collection device (2) at one end of the cantilever, and a wedge (15) is provided at the reader (1) for pressing the cantilever at the other end to bend the cantilever in a direction away from the sample collection device (2) to disconnect the cartridge (3) from the sample collection device (2).

4. The connection system (1, 2, 3) according to claim 1,
characterized in that the second locking device (6) is a ball-spring lock arranged at the reader (1) for engagement into a groove (31) designed in the cartridge (3) for releasably locking the cartridge (3) to the reader (1) before taking the sample.

5. The connection system (1, 2, 3) according to claim 1,
characterized in that the second locking device (6) exerts a force on the cartridge (3) perpendicular to the cartridge (3) and the sample collection device (2) resulting in a force in the axial direction to the cartridge (3) and the sample collection device (2) higher than exerted by the first locking device (5) allowing to release the sample collection device (2) from the cartridge (3) and the cartridge (3) locked with the reader (1).

6. The connection system (1, 2, 3) according to claim 1,
characterized in that a third locking device (8) is arranged at the cartridge (3) for irreversibly locking the sample collection device (2) with the cartridge (3) to withdraw the sample collection device (2) with the cartridge (3) from the reader (1).

7. The connection system (1, 2, 3) according to claim 6,
characterized in that the third locking device (8) is a clamp (24) arranged at the cartridge (3) for engagement into a groove (23) designed in the sample collection device (2) for irreversibly locking the cartridge (3) to the sample collection device (2) after taking the sample.

8. The connection system (1, 2, 3) according to claim 1,
characterized in that the reader (1) comprises an optical, magnetic, mechanical, acoustic, thermal or electrical sensor element for sensing the sample.

9. The connection system (1, 2, 3) according to claim 1,
characterized in that the connection system (1, 2, 3) comprises an indicator for detecting and indicating if sufficient sample is collected.

10. Method for the connection of a cartridge (3) to a cartridge reader (1),
connecting a sample collecting device (2) and a cartridge (3) to the reader (1),
releasing the sample collecting device (2) from the cartridge (3) leaving the cartridge (3) connected to the reader (1),
taking a sample by the sample collecting device (2),
irreversibly connecting the sample collecting device (2) with the cartridge (3) connected to the reader (1),
detecting the sample within the reader (1),
removing the sample collecting device (2) and the cartridge (3) irreversibly connected to the sample collecting device (2) from the reader (1).
